(19) United States
(12) Patent Application Publication
(10) Pub. No.: US 2019/0315077 A1
(43) Pub. Date: Oct. 17, 2019

(54) METHOD FOR FORMING STIFFENED COMPOSITE PARTS

(71) Applicant: GE Aviation Systems Limited, Gloucestershire (GB)

(72) Inventor: Stephen Mason, Farnborough (GB)

(21) Appl. No.: 16/461,243

(22) PCT Filed: Nov. 10, 2017
(86) PCT No.: PCT/EP2017/078949

§ 371 Date: May 15, 2019

(30) Foreign Application Priority Data
Nov. 16, 2016 (GB) 1619407.8

(51) Int. Cl. B29C 70/38; B29C 70/54

(52) U.S. Cl. CPC B29C 70/382; B29L 2031/3076; B29C 70/545

(57) ABSTRACT

A method for forming a composite part includes providing a core (22), providing a set of fiber bands (24), placing the set of fiber bands (24) in a set of predetermined positions, and fixing the set of fiber bands (24) at the set of predetermined positions through the use of a binder material, such as resin.

### BACKGROUND

Composite panels can include predesigned or preformed sub-panel or subcomponent designed or configured to be included in a structure. For example, composite panels can be included in vehicles such as ground, aquatic, or air-based vehicles. In vehicles, such as aircraft, composite panels can be used to build preassembled panels or substructures for larger aerostructures, such as the fuselage or the aircraft wings.

### BRIEF DESCRIPTION

In one aspect, the present disclosure relates to a method for forming stiffened composite parts, the method including cutting off relatively short fiber band pieces of a first length from a spread fiber band, placing the relatively short fiber band pieces at a set of predetermined positions on the core, and fixing the relatively short fiber band pieces at the set of predetermined positions through use of a binder material.

In another aspect, the present disclosure relates to a method of forming a composite panel assembly includes disposing a first layer of long fiber band pieces at a first set of predetermined positions, disposing a core adjacent to the first layer, disposing a second layer of short fiber band pieces at a second set of predetermined positions adjacent to the core wherein the short fiber band pieces are shorter than the long fiber band pieces, and fixing the first layer and the second layer through the use of a binder material.

### BRIEF DESCRIPTION OF THE DRAWINGS

In the drawings:

FIG. 1 illustrates an example cross-sectional view of a composite panel assembly in accordance with various aspects described herein.

FIG. 2 illustrates an example step of disposing a first layer of the composite panel assembly of FIG. 1, in accordance with various aspects described herein.

FIG. 3 illustrates an example step of disposing a second core layer of the composite panel assembly of FIG. 1, in accordance with various aspects described herein.

FIG. 4 illustrates an example step of disposing a third layer of the composite panel assembly of FIG. 1, in accordance with various aspects described herein

FIG. 5 illustrates an example cross sectional view of an edge of the composite panel assembly of FIG. 1, in accordance with various aspects described herein.

FIG. 6 is an example a flow chart diagram of demonstrating a method of for forming the composite panel assembly in accordance with various aspects described herein.

FIG. 7 is an example a flow chart diagram of demonstrating another method of for forming the composite panel assembly in accordance with various aspects described herein.

### DETAILED DESCRIPTION

Aspects of the disclosure can be implemented in any environment or apparatus utilizing panels, composite panels, or stiffened composite panels (referred to herein as “a composite panel” or “composite panels”). Aspects of the disclosure can also be implemented in a method for forming, manufacturing, configuring the composite panel, or the like.

While “a set of” various elements will be described, it will be understood that “a set” can include any number of the respective elements, including only one element. Additionally, while “a layer” will be described, it will be understood that “a layer” can include a set of layered elements, and is not limited to a single layer of the respective element or elements.

Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto can vary.

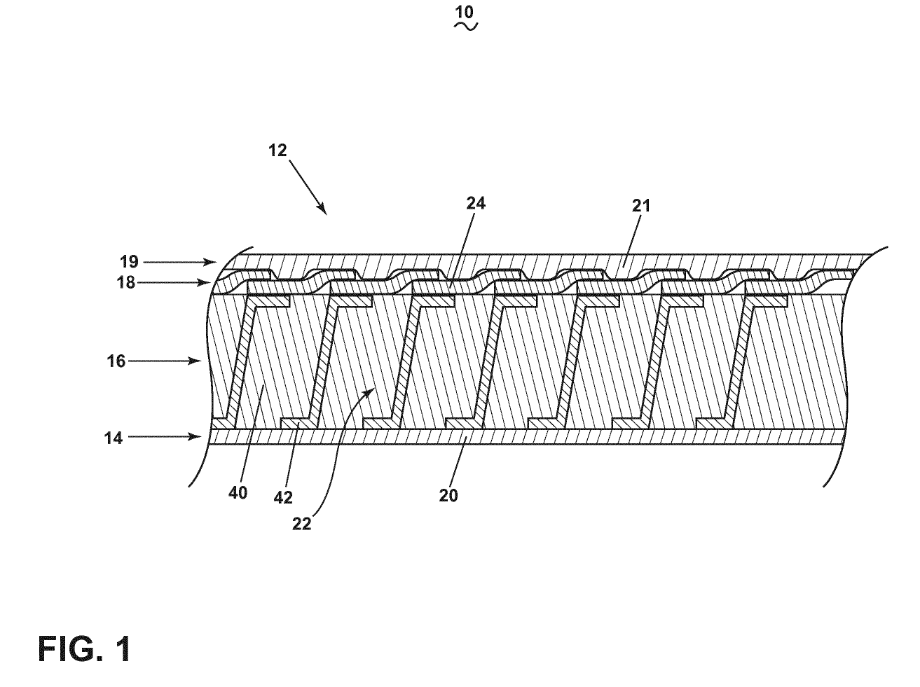

FIG. 1 illustrates a cross-sectional view of a stiffened composite panel assembly 10. The composite panel assembly 10 can include a composite panel 12 having a set of layers assembled to form a stiffened structure. In one non-limiting aspect of the disclosure, the composite panel 12 can include a first layer, such as a first carbon fiber layer 14, a second layer, such as a core 22 or core layer 16, a third layer, such as a second carbon fiber layer 18, and a fourth layer, such as a third carbon fiber layer 19. As used herein, the carbon fiber layers 14, 18, 19 or subset thereof can include dry carbon fiber material, including but not limited to, carbon fiber sheets, preformed carbon fiber structures, multi or single layer carbon fiber compositions, or other fiber elements or structures known.

In one non-limiting example configuration, the first carbon fiber layer 14 can include an assembled layer of a first carbon fiber 20. Likewise, the second and third carbon fiber layers 18, 19 can include assembled layers of, respectively, a second carbon fiber 24 and a third carbon fiber 21. Non-limiting aspects of the disclosure can be included wherein the first, the second, or the third carbon fibers 20, 24, 21 can include the same carbon fiber material, carbon fiber structure, or carbon fiber characteristics. In another non-limiting aspect of the disclosure, the first, the second, the third carbon fibers 20, 24, 21, or a subset thereof, can include the non-similar or different carbon fiber materials, carbon fiber structures, or carbon fiber characteristics. In one non-limiting configuration, at least a subset of the carbon fibers 20, 24, 21 can be selected or configured to be adhered, fixed, bound, or the like, through the use of a binder material. For instance, at least a subset of the carbon fibers 20, 24, 21 can be fixed to another of the carbon fibers 20, 24, 21 when combined, mixed, saturated, or included with a binder material, such as glue or resin.

As shown, the core layer 16 or core 22 can include a structurally supportive core material, including but not limited to a foam core 40. The foam core 40 can include, but is not limited to materials having or including density between 30 and 120 Kilograms per cubic meter (Kg/m³). In another non-limiting example, the foam core 40 can also include a set of foam core ties 42 inserted or integrated to provide improved or increased structure or rigidity, compared with a foam-only core 40. The ties 42, for example, can be preconfigured, or pre-assembled in the core 22 or foam core 40 by way of needling. The ties 42 can further provide predetermined or selectable structural reinforcement or rigidity to the core 22 or foam core 40, as desired. One non-limiting example of a foam core 40 structure having a set of ties 42 is described in U.S. Pat. No. 8,356,451. Additional core 22 configurations or structures can be included.

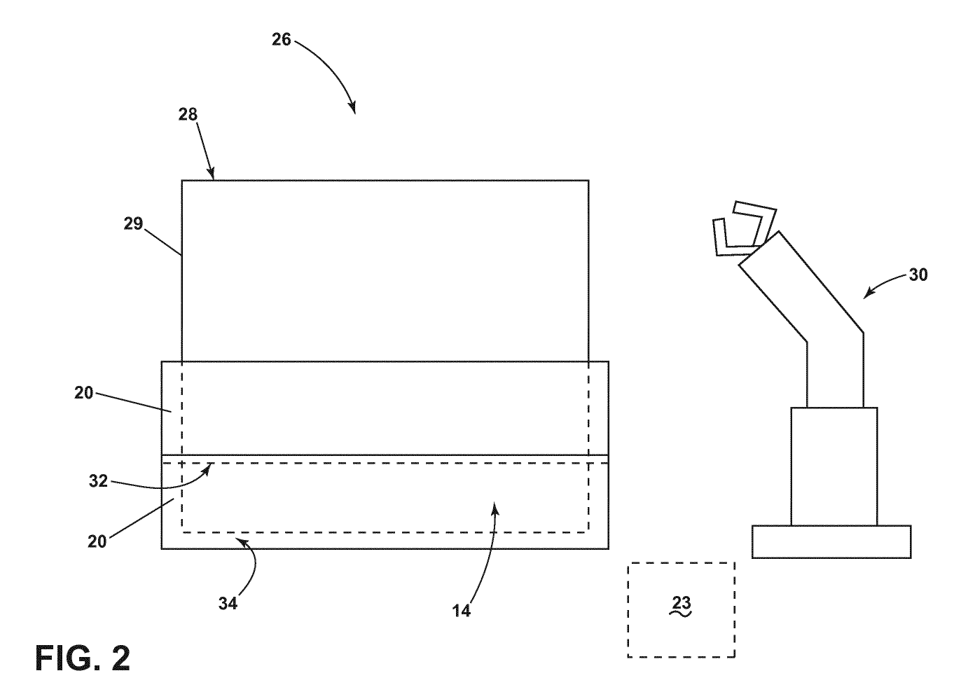

FIGS. 2 through 5 illustrate one non-limiting set of assembling steps for the composite panel assembly 10 or composite panel 12.

FIG. 2 illustrates an initially layering step of a partially assembled composite panel assembly 26. A composite panel frame 28, template, or mold can be provided to guide, define, relate to, or provide a reference for the assembled composite panel assembly 10. In this sense, the composite panel frame 28 can define a predefined form or predefined characteristics for the partially assembled composite panel assembly 26. For example, the composite panel frame 28 can include an edge 29 corresponding or related to the desired dimension of the assembled composite panel 12. The predefined form or predefined characteristics can include a two dimensional or three dimensional shape, including but not limited to, surface shape, contours, angles, dimensions (length, width), or the like. While a composite panel frame 28 is described herein, aspects of the disclosure can be include wherein the composite panel assembly 10 or partially assembled composite panel assembly 26 is arranged or assembled without a framing element.

The partially assembled composite panel assembly 26 can be initially layered with the first carbon fiber 20. In one non-limiting example, the first carbon fiber 20 can be received from a first carbon fiber material source 23, such as a spread fiber band or a roll of carbon fiber. In another non-limiting example, the first carbon fiber material source 23 can include a set of predefined, precut, or preselected carbon fiber elements, such as pre-sized sheets of the first carbon fiber 20. The first carbon fiber 20 can be arranged, layered, disposed, positioned, or the like on the composite panel frame 28 by way of an automated tool or machine, such as a first automated arm assembly 30. For example, the first automated arm assembly 30 can select one or more sections, layers, or swaths of pre-sized sheets of the first carbon fiber 20, and lay or dispose them in the composite panel frame 28 to define or assembly the first carbon fiber layer 14. In this sense, the disposing of the first carbon fiber 20 utilizes an automated fiber placement configuration. In one example configuration, the automated fiber placement configuration of the first carbon fiber 20 can including the disposing of meters of the first carbon fiber 20 each minute.

In another non-limiting aspect, the first automated arm assembly 30 can be configured to select or receive a portion of a continuous roll of carbon fiber from the carbon fiber material source 23, and cut, trim, or the like, the portion of the continuous roll to the appropriate or preselected dimensions of the first carbon fiber 20.

Regardless of the method or selection of the individual pieces of the first carbon fiber 20, the first carbon fiber 20 can be disposed on the composite panel frame 28 according to a predetermined pattern, or set of predetermined positions. Non-limiting aspects of the disclosure can include disposing or arranging the first carbon fiber 20 to overlap adjacent first carbon fiber 20 sheets (overlap illustrated in dotted line as 32), or to overlap the final dimensions of the composite panel assembly 10 or the composite panel frame 28 (overlap illustrated as 34). The dimension or arrangement of the overlaps 32, 34 can be included as part of the predetermined pattern. In one non-limiting example configuration, the dimension of overlap (32 or 34) can be approximately 80 millimeters. Additional or alternative overlap 32, 34 dimensions can be included.

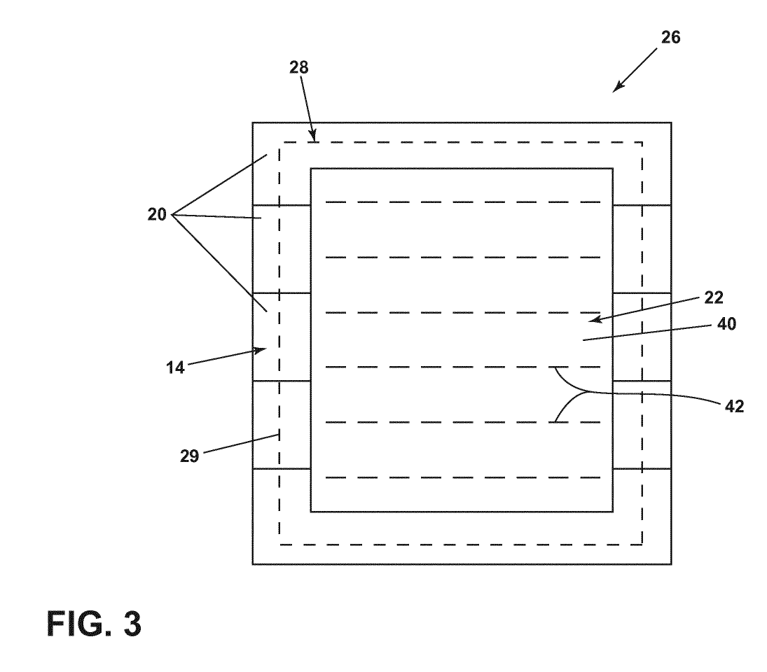

FIG. 3 illustrates another step of partially assembled composite panel assembly 26, wherein the core 22 is placed, provided, located, or disposed relative to the first carbon fiber layer 14. The size, shape, contours, or dimensions of the core 22 can be defined by the composite panel assembly 10 or the composite panel 12. Aspects of the disclosure can be included wherein the core 22 is automatically or manually dimensioned or placed at the partially assembled composite panel assembly 26, for instance.

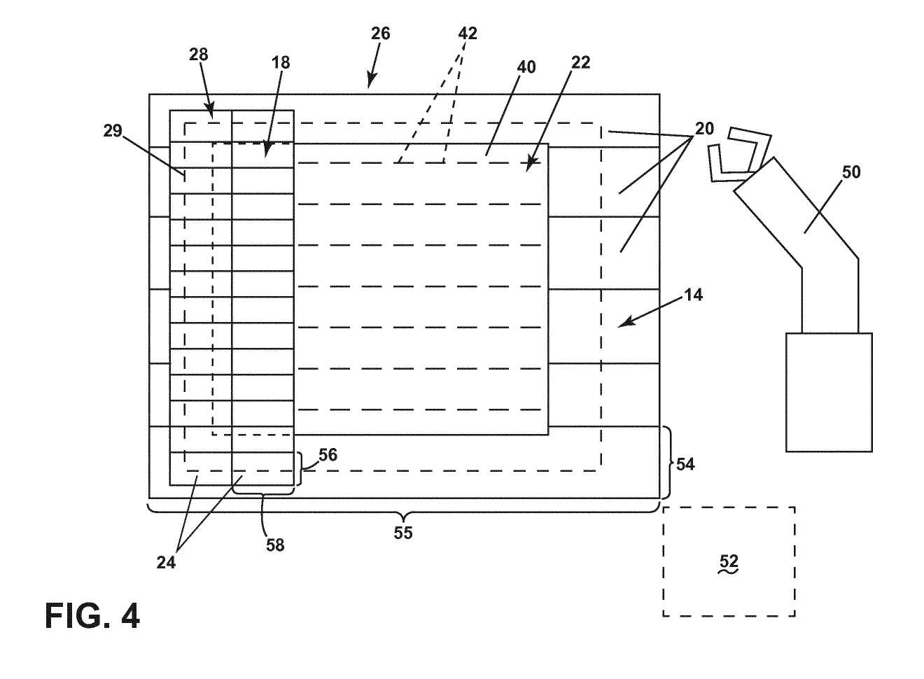

FIG. 4 illustrates the step of layering of the partially assembled composite panel assembly 26, such as the first carbon fiber layer 14 and the core 22, with the second carbon fiber layer 18. In one non-limiting example, the second carbon fiber 24 can be received from a second carbon fiber material source 52, such as a spread fiber band or a roll of carbon fiber. In another non-limiting example, the second carbon fiber material source 52 can include a set of predefined, precut, or preselected carbon fiber elements, such as pre-sized sheets or patches of the second carbon fiber 24. The second carbon fiber 24 can be arranged, layered, disposed, positioned, or the like on the first carbon fiber layer 14 or the core 22 by way of an automated tool or machine, such as a second automated arm assembly 50. For example, the second automated arm assembly 50 can select one or more sections, layers, or swaths of pre-sized sheets of the second carbon fiber 24, and lay or dispose them in the composite panel frame 28 to define or assembly the second carbon fiber layer 18. In this sense, the disposing of the second carbon fiber 24 utilizes an automated fiber patch placement configuration.

In another non-limiting aspect, the second automated arm assembly 50 can be configured to select or receive a portion of a continuous roll of carbon fiber from the second carbon fiber material source 52, and cut, trim, or the like, the portion of the continuous roll to the appropriate or preselected dimensions of the second carbon fiber 24.

Regardless of the method or selection of the individual pieces of the second carbon fiber 24, the second carbon fiber 24 can be disposed on the composite panel frame 28, the first carbon fiber layer 14, or the core 22 according to a predetermined pattern. Non-limiting aspects of the disclosure can include disposing or arranging the second carbon fiber 24 to overlap adjacent second carbon fiber 24 sheets, or to overlap the final dimensions of the composite panel assembly 10 or the composite panel frame 28. The dimension or arrangement of the overlaps can be included as part of the predetermined pattern. In one non-limiting example configuration, the dimension of overlap for the second carbon fiber 24 can be approximately 30 millimeters. Additional or alternative overlap 32, 34 dimensions can be included.

In another non-limiting example configuration, the second carbon fiber layer 18 can be layered with multiple second carbon fiber 24 sheets near or proximate to the edge 29 of the composite panel assembly 10, the partially assembled composite panel assembly 26, or the composite panel frame 28 to provide additional or increased structural rigidity, compared with at least one of the first carbon fiber layer 14 or portions of the second carbon fiber layer 18 disposed away from the composite panel frame 28. As used herein “proximate” to the edge 29 can include a span of distance between the core 22 and the edge 29.

As shown, the relative size of a first carbon fiber 20 can be defined by a first carbon fiber width 54 and a first carbon fiber length 55, and the relative size of the second carbon fiber 24 can be defined by a second carbon fiber width 56 and a second carbon fiber length 58. Non-limiting aspects of the disclosure can be included wherein the first carbon fiber width 54 can be larger compared with the second carbon fiber width 56 or the second carbon fiber length 58. In this sense, the second carbon fiber 24 can include a first length 58, and can be considered relatively short while the first carbon fiber 20 can have a second length 55, and can be considered relatively long. In the aforementioned examples, the first length 58 can be shorter than the second length 55, when compared with each other.

Following the disposition of the second carbon fiber layer 18, the process can include disposing the third carbon fiber layer 19 of the third carbon fiber 21 in substantially the same fashion as the first carbon fiber layer 19 of the first carbon fiber 20. In this sense, the third carbon fiber 21 is disposed over the first carbon fiber layer 14, the core 22, the second carbon fiber layer 18, or a combination thereof. The disposition of the third carbon fiber layer 19 has not been illustrated for brevity.

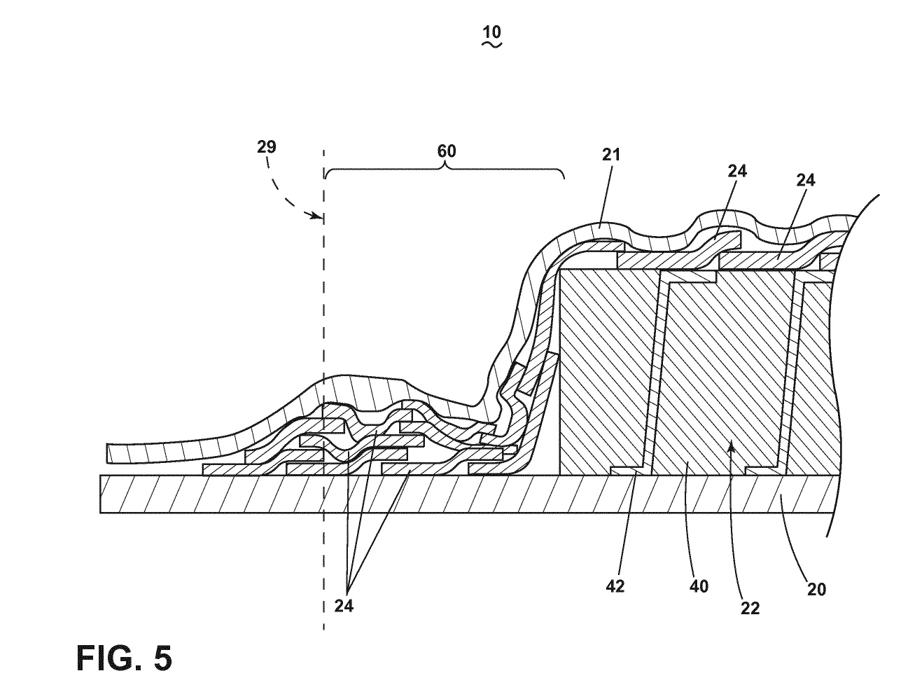

FIG. 5 illustrates a cross-sectional view of the composite panel assembly 10 taken proximate to the edge 29 of the composite panel 12. As shown, a portion 60 of the composite panel assembly 10 proximate to the edge 29, spanning a distance between the core 22 and the edge 29, and overlapping at least a portion of the composite panel frame 28 can include a set of multiple layers of the second carbon fiber 24 to provide additional or increased structural rigidity, compared with at least one of the first carbon fiber layer 14, as previously explained. Non-limiting aspects of the disclosure can be included wherein the composite panel is trimmed at the edge 29. Additional non-limiting aspects of the disclosure can be included wherein mounting holes, brackets, or mechanical fasteners can be included in the portion 60 and configured to connect the composite panel to a larger structure or aerostructure, such as the fuselage or wing of an aircraft.

While the dotted edge 29 is shown as a straight edge 29, cut, trim, or the like, non-limiting aspects of the disclosure can be included wherein the edge 29 is formed by way of additional or alternative methods or cutting tools. For instance, in one non-limiting example, the trimming at the edge 29 can include trimming at a non-perpendicular angle, relative to the first carbon fiber 20. A non-perpendicular angle can include, but is not limited to, 20 degrees, 40 degrees, 80 degrees, 110 degrees, etc. In another non-limiting example, the trimming at the edge 29 can include non-straight cuts, such as rounding or rounded edges, for example, by way of chamfering. In yet another non-limiting example, a non-straight edge can be rounded or chamfered to vary between a first angle and a second angle, such as chamfered from 20 degrees at a first position relative to the composite panel assembly 10 to 40 degrees at a second position relative to the composite panel assembly 10.

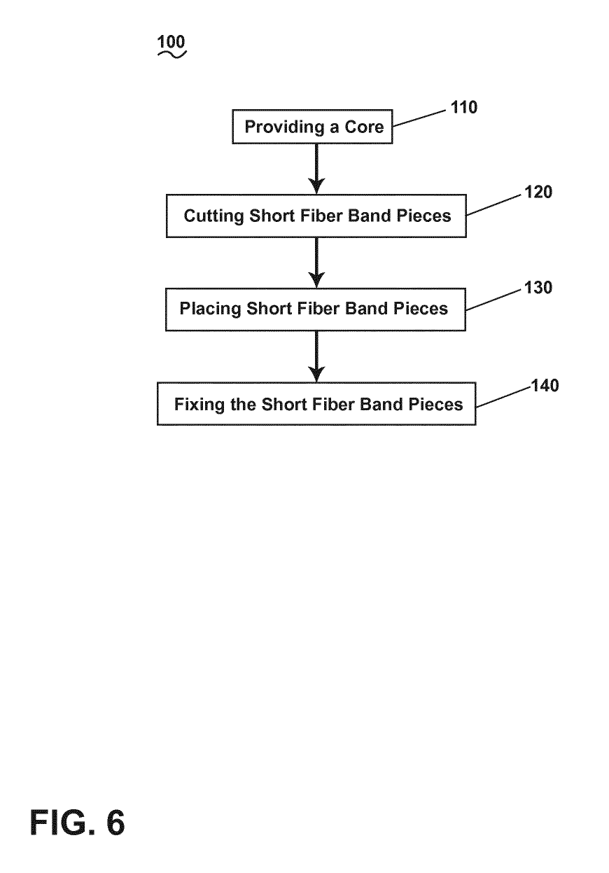

FIG. 6 illustrates a flow chart demonstrating one non-limiting method 100 for forming stiffened composite parts. The method 100 begins by providing a core 22, at 110. The method 100 continues by cutting off relatively short fiber band pieces from a spread fiber band, such as the second carbon fiber 24, at 120. Next, the method 100 includes placing the relatively short fiber band pieces at a set of predetermined positions, such as according to a predetermined pattern, on the core 22, at 103. The method 100 can also include fixing the relatively short fiber band pieces at the set of predetermined positions though the use of a binder material, such as resin, at 140.

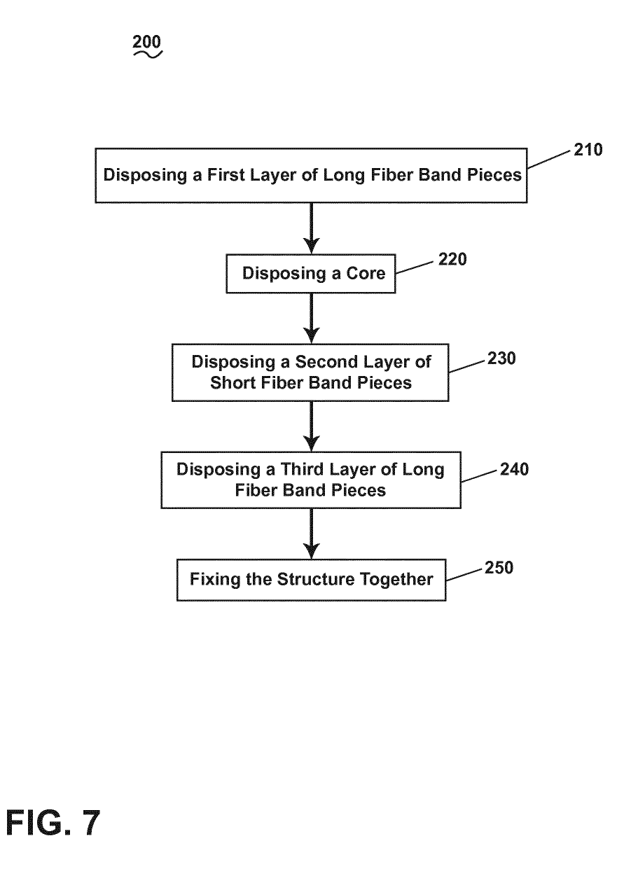

FIG. 7 illustrates a flow chart demonstrating another non-limiting method 200 for forming a composite panel assembly 10. The method 200 begins by disposing a first layer of relatively long fiber band pieces, such as the first carbon fiber 20, at a first set of predetermined positions or pattern, at 210. The method 200 continues by disposing a core 22 adjacent to the first layer, such as on a surface of the first layer, at 220. Next, the method 200 includes disposing a second layer of relatively short fiber band pieces, such as the second carbon fiber 24, at a second set of predetermined positions adjacent to the core 22, at 230. The method 200 can optionally include another step of disposing a third layer of relatively long fiber band pieces, such as the third carbon fiber 21, similar to the first carbon fiber 20, at 240. The method 200 can include fixing at least the first layer and the second layer through the use of a binder material, such as resin, at 250.

The sequences depicted are for illustrative purposes only and is not meant to limit the methods 100, 200 in any way as it is understood that the portions of the method can proceed in a different logical order, additional or intervening portions can be included, or described portions of the method can be divided into multiple portions, or described portions of the method can be omitted without detracting from the described method.

Aspects of the disclosure can be included wherein at least a subset of the carbon fiber layers 14, 18, 19, the core 22, or a combination thereof, can be bound together, using the binding material, such as resin. The binding can occur in a multi-step process, such as after the layering of each layer 14, 16, 18, 19, or in a single step, such as after the composite panel 12 is assembled. The binding can include additional steps, such as utilizing a vacuum or vacuum pump to remove air from the composite panel assembly 10 to ensure proper integrity or hardening of the binding material, as needed.

Many other possible aspects and configurations in addition to that shown in the above figures are contemplated by the present disclosure. For example, one non-limiting aspect of the disclosure contemplates a common fiber source 23, 52 or a common automated arm assembly 30, 50 is utilized by the disclosure to perform all assembly described herein. In another non-limiting aspect of the disclosure, the third carbon fiber layer 19 can be optionally included in the composite panel assembly 10 or the composite panel 12.

The aspects disclosed herein provide a method and configuration for assembling a stiffed composite part, element, or panel. One advantage that can be realized in the above aspects is that the above-described aspects can be assembled in an automated fashion, opposed to using a manual process of layering the composite layers or carbon fiber by hand. By automating the layering of the composite panel assembly, the overall costs of the panel assembly will be reduced. The automation can further increase the productivity and quality of the assembly process associated with the automation, while reducing scrap material from the precision of the predetermined layering patterns.

Another advantage of the above-described aspects is the utilization of both the automated fiber placement of the first and third carbon fiber layers, which is effective and efficient at placing larger selections of carbon fiber quickly over large areas. Similarly, the above-described aspects can further utilize the fiber patch placement configuration described for the second carbon fiber layer to quickly arrange or dispose smaller selections of carbon fiber about a non-linear or non-standard shape, such as around the core, while ensuring adequate or desired integrity of the composite panel assembly. The utilization of the fiber patch placement further provides the advantage of enabling selective reinforcement of key areas, such as where an edge will be located, or where fasteners will be connected.

Another advantage that can be realized is that utilizing the foam core as described, conventional core materials including honeycomb structures can be eliminated from the composite panel assembly. Honeycomb core structures can capture and trap binder materials, such as resin, leading to balance or structural integrity issues with the panel assembly.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for forming stiffened composite parts, the method comprising:
cutting off relatively short fiber band pieces of a first length from a spread fiber band;
placing the relatively short fiber band pieces at a set of predetermined positions on the core; and
fixing the relatively short fiber band pieces at the set of predetermined positions through use of a binder material.

2. The method of claim 1, further including placing relatively long fiber band pieces of a second length prior to providing the core, wherein the first length is shorter than the second length.

3. The method of claim 2, further including providing the core on the relatively long fiber band pieces, and wherein the placing the relatively short fiber band pieces includes placing the relatively short fiber band pieces on the core opposite of the relatively long fiber band pieces.

4. The method of claim 3, wherein the placing the relatively short fiber band pieces including placing relatively short fiber band pieces that have at least one of a length dimension or width dimension shorter than a width dimension of the relatively long fiber band pieces.

5. The method of claim 1 further including providing a composite part frame.

6. The method of claim 5, wherein the providing the core includes providing the core to the composite part frame, and wherein the placing the relatively short fiber band pieces include placing the relatively short fiber band pieces at a set of predetermined positions relative to the frame.

7. The method of claim 5, further including placing multiple layers of the relatively short fiber band pieces at predetermined positions of the composite part frame.

8. The method of claim 1 wherein placing the relatively short fiber band pieces includes placing the relatively short fiber band pieces at a set of predetermined positions by way of an automated arm assembly.

9. The method of claim 8, wherein the cutting off relatively short fiber band pieces includes cutting off relatively short fiber band pieces by way of the automated arm assembly.

10. The method of claim 1, further including trimming a portion of the stiffened composite parts based on a template.

11. The method of claim 1 wherein the stiffened composite parts are avionics parts.

12. The method of claim 1 wherein the fixing the relatively short fiber band pieces includes fixing the relatively short fiber band pieces at the set of predetermined positions through use of a resin binder material.

13. A method of forming a composite panel assembly, the method comprising:
disposing a first layer of long fiber band pieces at a first set of predetermined positions;
disposing a core adjacent to the first layer;
disposing a second layer of short fiber band pieces at a second set of predetermined positions adjacent to the core, wherein the short fiber band pieces are shorter than the long fiber band pieces; and
fixing the first layer and the second layer through the use of a binder material.

14. The method of claim 13, wherein disposing the second layer includes disposing
a second layer of short fiber band pieces, wherein the short fiber band pieces are selected to include at least one of a length dimension or width dimension shorter than a width dimension of the long fiber band pieces.

15. The method of claim 14, further including providing a composite panel frame.

16. The method of claim 15, disposing the first layer includes disposing the first layer onto the composite part frame.

17. The method of claim 15 wherein disposing the second layer includes disposing multiple overlapping layer of the short fiber band pieces at a portion of the composite panel assembly overlapping the composite panel frame but not overlapping the core.

18. The method of claim 14 wherein at least one of disposing the first layer or disposing the second layer includes disposing by way of an automated arm assembly.

19. The method of claim 18, wherein the at least one of disposing the first layer or disposing the second layer includes cutting the fiber band pieces by way of the automated arm assembly.

20. The method of claim 13, further including trimming a portion of the composite panel assembly based on a template.
